(19) United States
(12) Patent Application Publication
(10) Pub. No.: US 2026/0204258 A1
(43) Pub. Date: Jul. 16, 2026

(54) METHOD, APPARATUS, DEVICE AND STORAGE MEDIUM FOR INTERACTION

(71) Applicant: Beijing Zitiao Network Technology Co., Ltd., Beijing (CN)

(72) Inventors: Ziyang ZHENG, Beijing (CN); Yifan DING, Beijing (CN); Siyu LIU, Beijing (CN)

(21) Appl. No.: 19/445,224

(22) Filed: Jan. 9, 2026

(30) Foreign Application Priority Data
Jan. 13, 2025 (CN) 202510052167.0

(51) Int. Cl. G10L 15/22

(52) U.S. Cl. CPC G10L 15/22; G10L 2015/223

(57) ABSTRACT

Embodiments of the disclosure provide a method, an apparatus, a device, and a storage medium for interaction. The method includes: receiving, during a voice call between a user and a digital assistant, a first user input including at least a first voice input by the user to the digital assistant. First auxiliary content of a first modality associated with the first user input is obtained based on the first user input, the first modality being determined based on a user requirement indicated by the first user input. A voice reply for the first user input and a first preview view for the first auxiliary content are presented. In this way, the auxiliary content is matched to respond to the user while presenting the voice reply. Therefore, more intuitive and comprehensive information is provided for the user, thus improving the response efficiency of the digital assistant.

### CROSS-REFERENCE

This application claims the benefit of Chinese Patent Application No. 202510052167.0, filed on January 13, 2025 and entitled “METHOD, APPARATUS, DEVICE AND STORAGE MEDIUM FOR INTERACTION”, the entirety of which is incorporated herein by reference.

### FIELD

Example embodiments of the present disclosure generally relate to the field of computers, and in particular, to a method, an apparatus, a device and a computer-readable storage medium for interaction.

### BACKGROUND

With the rapid development of information technologies, various terminal devices may provide various services to people in terms of work and life. Applications providing services may be deployed on terminal devices. The terminal devices present corresponding content through user interfaces of the applications, and realize the question-and-answer interactions with the users, satisfying various requirements of the users. The terminal devices or applications may provide functions of a digital assistant-type to users to support better interactions with the users.

### SUMMARY

In a first aspect of the present disclosure, a method for interaction is provided. The method includes: receiving a first user input during a voice call between a user and a digital assistant, the first user input including at least a first voice input by the user to the digital assistant; obtaining, based on the first user input, first auxiliary content, of a first modality, associated with the first user input, where the first modality is determined based on a user requirement indicated by the first user input; and presenting a voice reply for the first user input and a first preview view for the first auxiliary content.

In a second aspect of the present disclosure, an apparatus for interaction is provided. The apparatus includes: a receiving module configured to receive a first user input during a voice call between a user and a digital assistant, the first user input including at least a first voice input buy the user to the digital assistant; an obtaining module configured to obtain first auxiliary content, of a first modality, associated with the first user input based on the first user input, where the first modality is determined based on a user requirement indicated by the first user input; and a presenting module configured to present a voice reply for the first user input and a first preview view for the first auxiliary content.

In a third aspect of the present disclosure, an electronic device is provided. The device includes at least one processor; and at least one memory coupled to the at least one processor and storing instructions for execution by the at least one processor. The instructions, when executed by the at least one processor, cause the electronic device to perform the method of the first aspect.

In a fourth aspect of the present disclosure, a computer-readable storage medium is provided. The medium stores a computer program, that, when the computer program is executed by a processor, implements the method of the first aspect.

It should be understood that the content described in this section is not intended to limit the key features or important features of embodiments of the present disclosure, nor is it intended to limit the scope of the present disclosure. Other features of the present disclosure will become readily understood from the following description.

### BRIEF DESCRIPTION OF DRAWINGS

The above and other features, advantages, and aspects of various embodiments of the present disclosure will become more apparent from the following detailed description taken in conjunction with the accompanying drawings. In the drawings, the same or similar reference numbers refer to the same or similar elements, where:

FIG. 1 illustrates a schematic diagram of an example environment in which embodiments of the present disclosure can be implemented;

FIG. 2A illustrates a schematic diagram of a first example interface for presenting reference media content according to some embodiments of the present disclosure;

FIG. 2B illustrates a schematic diagram of a second example interface for presenting reference media content according to some embodiments of the present disclosure;

FIG. 2C illustrates a schematic diagram of a first example interface for presenting first auxiliary content according to some embodiments of the present disclosure;

FIG. 2D illustrates a schematic diagram of a second example interface for presenting a plurality of preview views according to some embodiments of the present disclosure;

FIG. 3A illustrates a schematic diagram of a third example interface for presenting reference media content according to some embodiments of the present disclosure;

FIG. 3B illustrates a schematic diagram of a second example interface for presenting first auxiliary content according to some embodiments of the present disclosure;

FIG. 4A illustrates a schematic diagram of a fourth example interface for presenting reference media content according to some embodiments of the present disclosure;

FIG. 4B illustrates a schematic diagram of a third example interface for presenting first auxiliary content according to some embodiments of the present disclosure;

FIG. 4C illustrates a schematic diagram of a first example interface for presenting updated reference media content according to some embodiments of the present disclosure;

FIG. 5A illustrates a schematic diagram of a fifth example interface for presenting reference media content according to some embodiments of the present disclosure;

FIG. 5B illustrates a schematic diagram of an example interface when first auxiliary content is being generated some embodiments of the present disclosure.

FIG. 5C illustrates a schematic diagram of a fourth example interface for presenting first auxiliary content according to some embodiments of the present disclosure;

FIG. 6 illustrates a flowchart of a method for interaction according to some embodiments of the present disclosure;

FIG. 7 illustrates an example structural block diagram of an apparatus for interaction according to some embodiments of the present disclosure; and

FIG. 8 illustrates a block diagram of an electronic device in which one or more embodiments of the present disclosure may be implemented.

### DETAILED DESCRIPTION

Embodiments of the present disclosure will be described in more detail below with reference to the accompanying drawings. While certain embodiments of the present disclosure are shown in the accompanying drawings, it should be understood that the present disclosure may be implemented in various forms, and should not be construed as limited to embodiments set forth herein, but rather, these embodiments are provided for a more thorough and complete understanding of the present disclosure. It should be understood that the drawings and embodiments of the present disclosure are for example purposes only and are not intended to limit the scope of the present disclosure.

In the description of embodiments of the present disclosure, the terms “including” and the like should be understood to include “including but not limited to”. The term “based on” should be understood as “based at least in part on”. The terms “one embodiment” or “the embodiment” should be understood as “at least one embodiment”. The term “some embodiments” should be understood as “at least some embodiments”. Other explicit and implicit definitions may also be included below.

Herein, unless explicitly stated, performing one step “in response to A” does not imply that this step is performed immediately after “A”, but may include one or more intermediate steps.

It may be understood that the data involved in the technical solution (including but not limited to the data itself, the obtaining, using, storing or deleting of the data) should follow the requirements of the corresponding laws and regulations and related regulations.

It can be understood that before using the technical solutions disclosed in embodiments of the present disclosure, relevant users should be informed of the types, use ranges, usage scenarios, and the like of the information related to the present disclosure in an appropriate manner according to relevant laws and regulations, and the authorization of the related users may be obtained, wherein the relevant users may include any type of rights subject, such as individuals, businesses, and groups.

For example, in response to receiving an active request of a user, prompt information is sent to the related user to explicitly prompt the related user, and the operation requested to be performed will need to obtain and use the information of the related user, so that the related user can autonomously select whether to provide information to software or hardware such as electronic devices, applications, servers, or storage medium, etc., performing the operation of the technical solution of the present disclosure according to the prompt information.

As an optional but non-limiting implementation, in response to receiving an active request of a related user, a manner of sending prompt information to the related user may be, for example, using a pop-up window, and prompt information may be presented in a text manner in the pop-up window. In addition, the pop-up window may further carry a selection control for the user to select “agree” or “not agree” to provide information to the electronic device.

It may be understood that the foregoing notification and the process of obtaining the user authorization are merely illustrative, and do not constitute a limitation on implementations of the present disclosure, and other manners of meeting related laws and regulations may also be applied to implementations of the present disclosure.

As used herein, the term “model” may learn an association relationship between respective inputs and outputs from training data such that a corresponding output may be generated for a given input after training is complete. The generation of the model may be based on machine learning techniques. Deep learning is a machine learning algorithm that processes an input and provides a corresponding output by using a multi-layer processing unit. The neural network model is an example of a deep learning-based model. As used herein, a “model” may also be referred to as a “machine learning model,” a “learning model,” a “machine learning network,” or a “learning network,” which terms are used interchangeably herein.

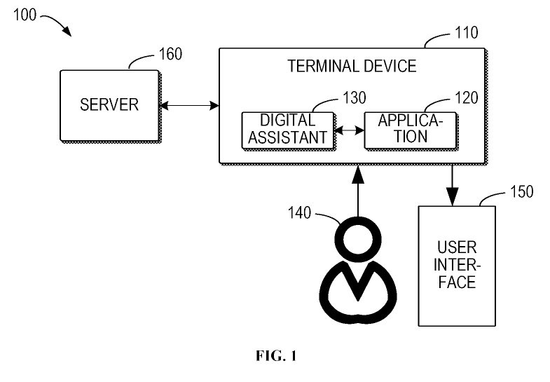

FIG. 1 illustrates a schematic diagram of an example environment 100 in which embodiments of the present disclosure can be implemented. In this example environment 100, a digital assistant 130 of an application 120 is installed in a terminal device 110. A user 140 may interact with the application 120 via the terminal device 110 and/or an attachment device of the terminal device 110. For example, the application 120 may be a chat application (also referred to as an instant messaging application), a document application, an audio and video conference application, a mail application, a task application, a calendar application, a target and key result (OKR) application, and the like. It may be understood that although a single application 120 is shown in FIG. 1, multiple applications 120 may be installed in the terminal device 110 in practice.

The digital assistant 130 may be configured with an intelligence dialogue function. In the example shown in FIG. 1, the digital assistant 130 may be configured as a stand-alone application, such as a web application or other type of application. In other examples, the digital assistant 130 may be integrated in the application 120.

The user may interact with the digital assistant 130. During the interaction, the user inputs an interaction message, and the digital assistant 130 provides a reply message in response to the user’s input. Generally, the digital assistant 130 can support the user to input a question in a manner of natural language and perform a task and provide a reply based on understanding of the natural language input and logical reasoning capabilities. In some embodiments, depending on the configuration of the application 120, the interaction message with the application 120 may include messages in a multimodal form, such as a text message (e.g., natural language text), a voice message, an image message, a video message, and the like.

In the environment 100 of FIG. 1, the terminal device 110 may present a user interface 150 of the application 120. The user interface 150 may include various types of interfaces that the application 120 can provide, such as an interaction interface between the user 140 and the digital assistant 130. The interaction interface may include, for example, a chat window between the user 140 and the digital assistant 130.

In some embodiments, the digital assistant 130 may be associated to a respective database, which stores data or information required for the digital assistant 130 to answer the interaction information from the user. For example, in response to the user input, the digital assistant 130 may obtain information indicated by the user from a database (for example, a knowledge base for storing historical interaction information between the user 140 and the digital assistant, or a database for storing guidance information or instruction information) connected to the application 120. The digital assistant 130 may provide a respective answer to the user according to the obtained operation data and device information and according to the question or requirement raised by the user.

In some embodiments, the terminal device 110 communicates with a server 160 to implement the provision of services for the application 120. The terminal device 110 may be any type of mobile terminal, fixed terminal, or portable terminal, including a mobile phone, a desktop computer, a laptop computer, a notebook computer, a netbook computer, a tablet computer, a media computer, a multimedia tablet, a personal communication system (PCS) device, a personal navigation device, a personal digital assistant (PDA), an audio/video player, a digital camera/camcorder, a positioning device, a television receiver, a radio broadcast receiver, an electronic book device, a gaming device, or any combination of the foregoing, including accessories and peripherals of these devices, or any combination thereof. In some embodiments, the terminal device 110 can also support any type of interface for a user (such as a “wearable” circuit, etc. ). The server 160 may be various types of computing systems/servers capable of providing computing power, including, but not limited to, mainframes, edge computing nodes, computing devices in a cloud environment, and the like.

It should be understood that the structures and functions of the various elements in the environment 100 are described merely for purposes of illustration without any limitation to the scope of the present disclosure.

As mentioned above, terminal devices or applications may provide services (such as an information query, a text processing, etc.) to users through a digital assistant. However, most of the search results provided by the digital assistant are in the form of voice or text, resulting in that the digital assistant cannot provide an accurate and intuitive search result for the users, and satisfaction of the users is often low.

Given that, according to embodiments of the present disclosure, a solution for interaction is provided. Specifically, during a voice call between a user and a digital assistant, a first user input is received. The first user input includes at least a first voice input by the user to the digital assistant. First auxiliary content of a first modality associated with the first user input is obtained based on the first user input. A voice reply for the first user input and a first preview view for the first auxiliary content are presented.

According to the solution of the present disclosure, while presenting the voice reply for the user input, the auxiliary content of a proper modality is matched to provide more intuitive and comprehensive information, thereby improving the response efficiency of the digital assistant.

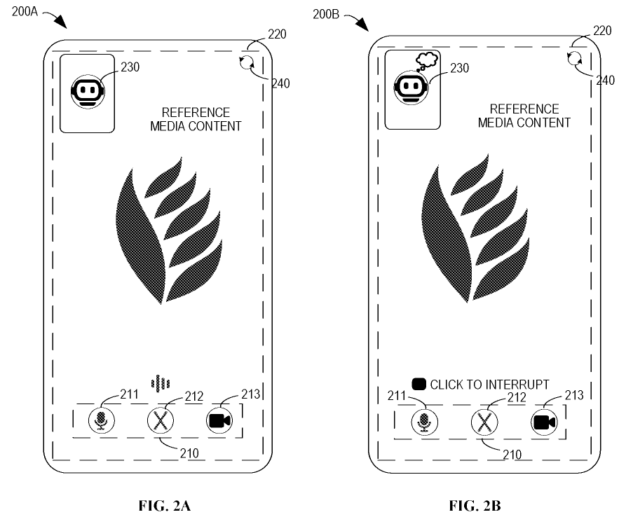

Some example embodiments of the present disclosure will be described below with continued reference to the accompanying drawings. FIGS. 2A-5C illustrate example interfaces 200A- 500C according to some embodiments of the present disclosure. The example interface 200A to the example interface 500C may be provided by, for example, the server 160 or the terminal device 110 shown in FIG. 1, or may be provided by the server 160 in cooperation with the terminal device 110. Here, the solution is described with respect to that the example interfaces are provided by the server 160 as an example.

The digital assistant may provide a service for the user in the form of a voice call. During the voice call between the user and the digital assistant 130, the server 160 receives the first user input. The first user input includes at least a first voice input by the user to the digital assistant 130. For example, the first user input may indicate an object recognition request, a recipe search request, a problem-solving request, a video processing request, or the like. The first voice input indicates a service request by the user for the digital assistant. FIG. 2A illustrates a schematic diagram of a first example interface 200A for presenting reference media content according to some embodiments of the present disclosure. As shown in FIG. 2A, the example interface 200A includes an interaction entry 210, a content presenting area 220 for presenting media content, and a state identification 230 for presenting a current operation state of the digital assistant. The interaction entry 210 is configured to obtain an interaction operation by the user to the digital assistant (such as starting a voice call, ending a voice call, etc. ). For example, the interaction entry 210 may include an audio control 211 for turning on or turning off the audio, and a voice call control 212 for turning on or turning off the voice call. If it is detected that the audio control 211 and the voice call control 212 are turned on, the digital assistant 130 receives the first user input and provides the first user input to the server 160. In some embodiments, the operation state of the digital assistant 130 may include an input state indicative of obtaining the user input and an output state indicative of presenting streaming media content, etc. The user input may be various types of information, such as information related to questions, queries. For example, the user input may be an interaction message issued to the digital assistant.

In some embodiments, the first user input may include reference media content associated with the first voice input. As shown in FIG. 2A, the interface 200A includes a video control 213 for turning on or turning off the video. If the selection operation for the video control 213 is detected, the reference media content uploaded by the user is received. The reference media content includes content of a static type (such as an image, etc.) and content of a dynamic type (such as a video or an audio, etc.). In some embodiments, the first voice input indicates a requirement for the reference media content. For example, the first voice input may indicate to identify an element in the reference media content, or to perform image processing on the reference media content. In some embodiments, the reference media content may serve as supplemental content for the first voice input. For example, if the first voice input is “solving this mathematical problem”, the reference media content may be an image including a mathematical problem.

In some embodiments, the reference media content may be an image and a video captured by the user in advance, or an image and a video captured by the user in real time are determined as the reference media content. In some embodiments, the first user input may include indication information indicating the reference media content. In this case, the reference media content associated with the first voice input may be determined based on the indication information. The indication information may be in the form of text or voice. In some embodiments, the indication information provided by the user may include a storage path or an internet link for the reference media content. In some embodiments, the indication information provided by the user may be natural language. The user input is provided to a machine learning model (e.g., a large language model) to determine the reference media content based on the semantics of the user input. In this way, the service request is provided to the digital assistant through the first user input including the first voice input and the reference media content, to enable the search result of the digital assistant to better satisfy the user expectations.

In some embodiments, the interface 200A further includes a content presenting area 220 for presenting reference media content. If it is detected that the first user input includes the reference media content, the reference media content is presented in the content presenting area 220 for the user to view. In some embodiments, the interface 200A further includes a update control 240 for updating the reference media content. If it is detected that the update control is selected, the step of obtaining the reference media content is performed again to update the reference media content. Subsequently, the updated reference media content is presented in the content presenting area 220.

In some embodiments, the server 160 obtains first auxiliary content of a first modality associated with the first user input based on the first user input. The first auxiliary content may be a portion of a reply for the first user input to provide a search service for the user. For example, the first auxiliary content may be complementary to the voice reply for the first user input, so as to act as an auxiliary of the voice reply to provide a more accurate search result for the user. The first auxiliary content may include an element mentioned by the voice reply. For example, if the voice reply mentions the structure of a nucleus, the first auxiliary content may be an image including the nucleus.

In some embodiments, the server 160 generates a voice reply for the first user input based on the first user input. The voice reply may be an audio determined using a machine learning model (e.g., a large language model), or the voice reply for the first user input may be determined by a search manner. For example, for the object A, the audio for describing the object A may be obtained from the Internet in a search manner. In some embodiments, the voice reply for the first user input may be first determined. Then, the first auxiliary content of the first modality is determined based on the content of the voice reply. In some embodiments, the first auxiliary content may be a content stream generated by the machine learning model. For example, the voice reply may be provided to the machine learning model, and the first auxiliary content may be obtained based on the output of the machine learning model. In some embodiments, the first auxiliary content may be determined from a plurality of predetermined content streams. For example, the auxiliary content related to the voice reply may be determined from a plurality of pre-generated content streams by a manner of keyword search or pattern matching. For example, if the voice reply is an explanation audio for the nucleus, an explanation video related to the nucleus may be determined by a search manner. Subsequently, the first auxiliary content is generated based on the explanation video and the semantic reply.

In some embodiments, the first auxiliary content may be determined using the machine learning model based on the first user input or the first voice input. For example, the first voice input may be provided to the machine learning model to obtain the first auxiliary content, related to the first user input, generated by the machine learning model.

In some embodiments, a modality of the first auxiliary content may be text, an image, a card, a video, an audio, or the like. In some embodiments, the modality of the first auxiliary content may be determined based on semantics of the first user input. The semantics of the first user input may indicate a user requirement. For example, the user requirement may include a none explanation, a weather query, and the like. In some embodiments, the machine learning model may be used to determine the semantics of the first user input, thereby determining the user requirement. If it is detected that the voice reply of the digital assistant cannot satisfy the user requirement, it may be determined that the auxiliary content needs to be obtained. For example, if the user requirement is to solve a mathematical problem, only providing the voice reply cannot satisfy the user requirement. In this case, based on the user requirement, the modality matching the user requirement may be determined from the plurality of modalities as the first modality of the first auxiliary content. Subsequently, content of the first modality is determined as the first auxiliary content based on the first user input. For example, if the user requirement is the none explanation, encyclopedia content related to the noun to be explained may be presented in the form of a card. If the user requirement is the weather query, weather information may be presented in the form of a weather card. In some embodiments, the user requirement may be determined by keywords in the first user input. For example, if the first user input includes a “video” keyword, it is determined that the first modality is the video. The above process may utilize, at least in part, the machine learning model. For example, the machine learning model may determine that the voice reply cannot satisfy the user requirement and determine the desired modality accordingly. Further, the machine learning model may generate auxiliary content of the modality, or generate information (for example, a parameter of a card) required to obtain the auxiliary content of the modality. In the above example process of using the machine learning model, one or more times of interactions with the model may be implemented. It should be understood that, in embodiments of the present disclosure, one time of interaction with the model is a process of providing a prompt to the model and obtaining a model output.

In some embodiments, the user requirement may be related to an information query (such as a plant species query, a weather query, a stock query, a literacy or local life information query, etc.). As shown in FIG. 2A, the first user input indicates to query information of the plant in the image provided by the user. If the content of the plant information is too large, the digital assistant can only provide a voice reply, which may cause inconvenience to the user. In this case, a structured card may be selected as the first modality. FIG. 2C illustrates a schematic diagram of a first example interface for presenting first auxiliary content according to some embodiments of the present disclosure. The structured card corresponding to content of the user query is generated based on the first user input. As shown in FIG. 2C, the structured card 250 is presented in the interface 200C as an auxiliary to the voice reply of the digital assistant .

In some embodiments, if the user requirement is related to a visual element, the voice reply cannot satisfy the user requirement. For example, the user requirement is to solve a mathematical problem, and the problem-solving method provided by the digital assistant includes drawing an auxiliary line. In this case, the problem-solving method cannot be clearly explained by the voice reply. Therefore, in order to display the auxiliary line to the user, an image may be selected as the first modality. The auxiliary line is presented in the image as the auxiliary to the voice reply of the digital assistant .

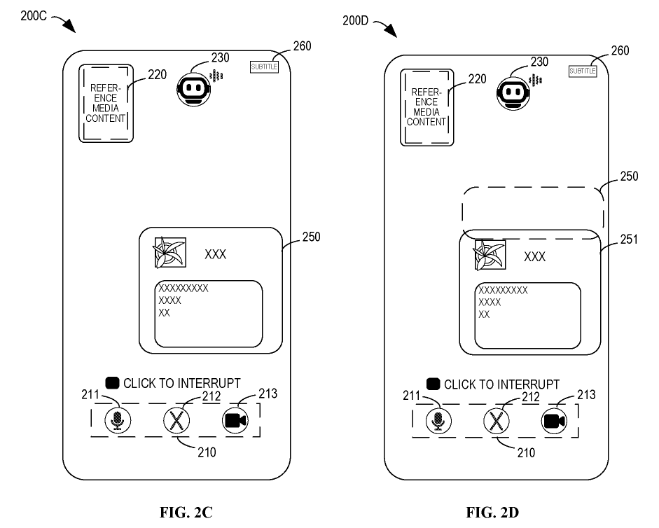

In some embodiments, if the user requirement is related to a dynamic scene, the voice reply cannot satisfy the user requirement. Thus, a video may be selected as the first modality. For example, the first user input may be “What dishes can be made using the ingredients in the picture”, and the first user input includes reference media content, which includes an element related to the ingredients. FIGS. 3A and 3B illustrate such interaction examples. The server 160 determines a voice reply and first auxiliary content for the first user input based on the ingredients in the provided reference media content. The first auxiliary content may be a video 310. As shown in FIG. 3B, the voice related to a recipe and a first preview view for the video 310 are presented in the interface 300B. If a trigger for the first preview view is detected, the video 310 is presented.

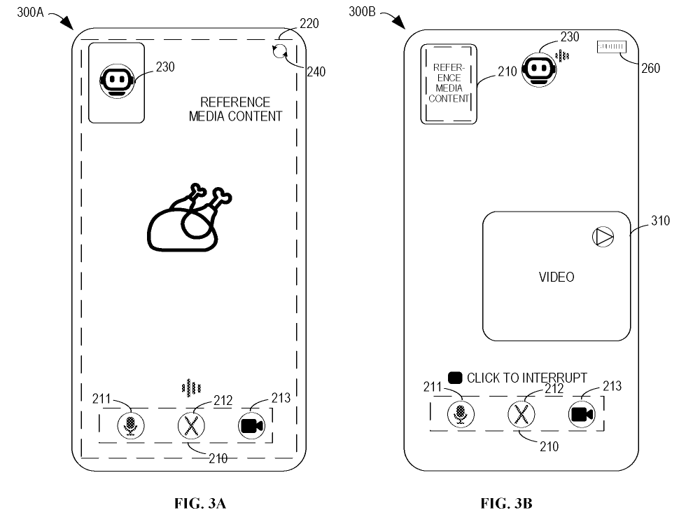

In some embodiments, after the digital assistant 130 presents the voice reply and the first auxiliary content, response content may be generated again based on feedback from the user. FIGS. 4A-4C illustrate such interaction examples. The server 160 generates streaming media content 410 including problem-solving steps based on the problem uploaded by the user. As shown in FIG. 4B, an interface 400B includes prompt information 430. The prompt information 430 is used to identify a designated area 420 of the streaming media content. The designated area 420 corresponds to current voice content. As shown in FIG. 4C, if the presented streaming media content 410 includes the step of drawing the auxiliary line, the image or video including the auxiliary line drawn by the user may be served as updated reference media content. Subsequently, the server 160 may generate a new problem-solving video based on the updated reference media content and the generated voice reply. In this way, the digital assistant can more flexibly satisfy the user request without frequently turning on the new voice call.

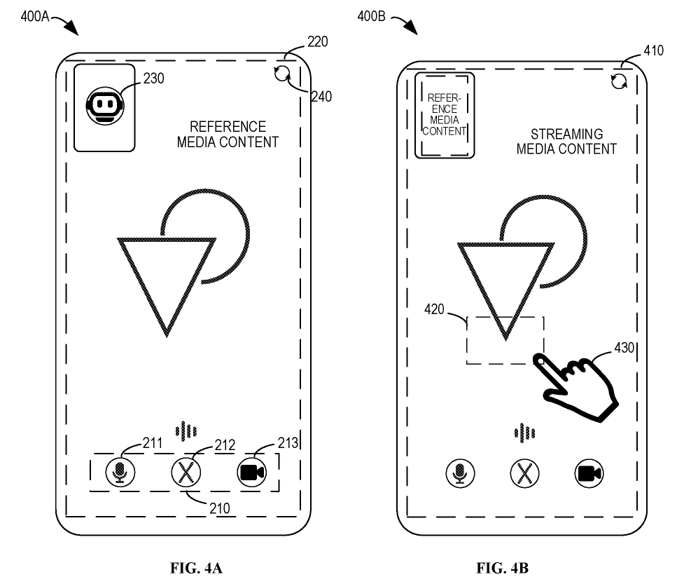

In some embodiments, the user requirement may be related to an auditory element. For example, the user requirement includes matching a music for a video uploaded by the user. The digital assistant may generate a matching music according to the video uploaded by the user. Thus, an audio may be selected as the first modality. For example, FIGS. 5A-5C illustrate such interaction examples. If it is detected that the first user input includes the video as the reference media content, and the first user input indicates to generate a music for the video. The server 160 may generate the corresponding music using the machine learning model. As shown in FIG. 5C, a preview view of streaming media content 520 may be presented in an interface 500C. The streaming media content 520 is a combination of the reference media content and the music for the reference media content. If a trigger for the preview view of the streaming media content 520 is detected, the streaming media content 520 is presented in full screen. In some embodiments, the digital assistant 130 may only present the generated music.

In some embodiments, if the user requirement cannot be accurately determined, content of the voice reply for the first user input may be determined first. Subsequently, the modality of the first auxiliary content is determined according to the content of the voice reply. For example, if the first user input is “Please provide a recipe including XXX”. In this case, the content of the voice reply related to the recipe may be determined first, and then it is determined whether the content is suitable for the modality of video. If suitable, it is determined that the modality of the first auxiliary content is the video. In some embodiments, whether it is suitable for the modality of video may be determined based on a presentation form commonly used for the content of the voice reply. In some embodiments, the obtained first auxiliary content may include media content of a plurality of modalities. In this way, the first modality corresponding to the user input may be selected from the plurality of modalities, thereby determining the content of the first modality as the first auxiliary content. Therefore, the quality of the search service provided by the digital assistant is further improved.

In some embodiments, the server 160 presents a voice reply for the first user input and a first preview view for the first auxiliary content. The first preview view may be a portion of the first auxiliary content. For example, if the first auxiliary content is video content, the first preview view may be a first frame or a cover of the video content. If the first auxiliary content is a card, the first preview view may be an overview for the card. In some embodiments, if the amount of the first auxiliary content is small (e.g., the first auxiliary content is a small amount of text), the first preview view may include all of the first auxiliary content.

In some embodiments, if a trigger operation on the first preview view is detected, at least a portion of the first auxiliary content (e.g., some portion of the video or audio, a portion of the recommended card, etc.) is presented during the voice call. In some embodiments, the trigger operation on the first preview view includes a click operation on the first preview view, and a trigger request sent by the user to the digital assistant 130.

In some embodiments, the first auxiliary content may include audio content. The audio content may be of various suitable types. As an example, the audio content may include an audio in a video. For example, if the first user input is a problem-solving request, the first auxiliary content may be an explanation video for the problem of the user input, and the audio content may be the audio in the explanation video. As another example, the audio content may include a pure music or a music in the video. For example, if the first user input indicates to add a music for the user input, the audio content may include the generated music. As yet another example, the audio content may include an audio for the voice of the user input. During the voice call between the user and the digital assistant 130, a voice output of the digital assistant 130 (including the voice reply for the first user input and the voice output for other content) may affect the user in listening to the audio content of the first auxiliary content, thus affecting the user experience. Thus, during presentation of at least a portion of the first auxiliary content, the voice output of the digital assistant 130 may be disabled. For example, with reference to the example of FIG. 3B, during presentation of the video 310, the voice output of the digital assistant 130 may be disabled. In some embodiments, the digital assistant 130 may receive a user voice input normally during presentation of the first auxiliary content.

In some embodiments, if second auxiliary content of a second modality is obtained during the voice call, a second preview view for the second auxiliary content is presented. In some embodiments, the first modality and the second modality may be the same modality, but the contents of the first auxiliary content and the second auxiliary content are different. For example, both the first modality and the second modality are images, but the first auxiliary content indicates recipe A and the second auxiliary content indicates recipe B. In some embodiments, the first auxiliary content and the second auxiliary content may indicate the same content, but the first modality and the second modality are different modalities. For example, both the first auxiliary content and the second auxiliary content indicate a mathematical definition A, but the modality of the first auxiliary content is a text, and the modality of the second auxiliary content is an image.

In some embodiments, the second auxiliary content may be obtained based on the first user input. In this case, the second auxiliary content is used to provide an auxiliary explanation for the voice reply for the first user input. For example, if the voice reply indicates information of “Plant A”, the first auxiliary content may be a card of an encyclopedia including “Plant A”, and the second auxiliary content may be an image including “Plant A”.

In some embodiments, a second user input may be received during presentation of the first auxiliary content (or the first preview view). The second auxiliary content of the second modality associated with the second user input is obtained based on the second user input. Subsequently, a voice reply for the second user input and a second preview view for the second auxiliary content are presented. The second preview view may be presented in the same interface with the first preview view. For example, the first preview view and the second preview view may be sequentially presented in the interface according to the generation order of the first auxiliary content and the second auxiliary content. The first preview view and the second preview view may be partially overlapped to highlight auxiliary content corresponding to the current voice reply, thus facilitating the user to view the auxiliary content. In some embodiments, only the newly generated second preview view may be presented in the interface. During presentation of the first auxiliary content, if it is detected that the second auxiliary content is generated, other auxiliary content and other preview views presented on the page are cleared.

In some embodiments, during presentation of at least a portion of the second auxiliary content (e.g., the second auxiliary content or the second preview view), at least a portion of the first auxiliary content or the voice reply for the first user input is presented in response to receiving a trigger for the first preview view. In some embodiments, if a request (e.g., a swiping-up operation) on a query historical dialog is detected, a plurality of historical preview views corresponding to the historical auxiliary content are presented in the interface according to the request. If a selection of a historical preview view is detected, the historical auxiliary content related to the historical preview view and a voice reply corresponding to the auxiliary content are presented.

In some embodiments, the first user input may indicate a query operation for a physical object A, and the first auxiliary content presented by the digital assistant 130 may be a structured card. For example, the first user input may be “what is the plant in the picture” and the first user input includes reference media content that includes an element related to the plant. As shown in FIGS. 2A-2D, such interaction examples are shown. In FIG. 2A, the user voice input and reference media content 220 related to the first user input are provided. As shown in FIG. 2B, after receiving the first user input, an interface that the digital assistant 130 is generating the search result may be presented. In this way, the user can more intuitively participate in the process of the digital assistant providing the search service.

As shown in FIG. 2C, the digital assistant 130 presents the voice reply for the first user input in the interface 200C while presenting a preview view of a structured card 250. The structured card 250 may serve as auxiliary content for the voice reply. The structured card 250 includes encyclopedia knowledge related to plants in the reference media content. If a trigger for the preview view of the structured card 250 is detected, all encyclopedia knowledge included in the structured card 250 is presented. As shown in FIG. 2D, preview views of a plurality of structured cards (e.g., structured card 250 and structured card 251) may be presented in the interface 200D. The preview views of the plurality of structured cards may be partially overlapped. The newly generated structured card is located at the top for selection by the user. In some embodiments, the reference media content included in the first user input may be presented in the interface 200C and the interface 200D for comparison and viewing.

In some embodiments, if the first auxiliary content includes voice content, a subtitle enabling control 260 is presented in the interface of the voice call. If a trigger for the subtitle enabling control 260 is detected, text corresponding to the voice content is presented during presentation of at least a portion of the first auxiliary content.

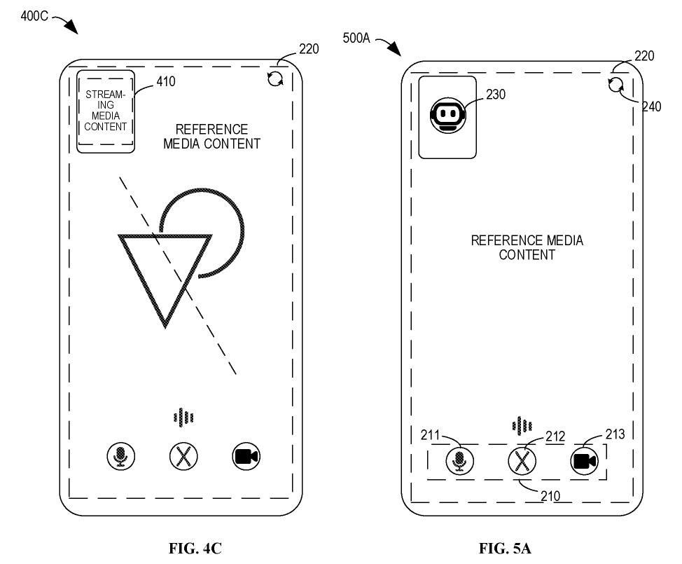

FIG. 6 illustrates a flowchart of an example process 600 of obtaining rich media content according to some embodiments of the present disclosure. For ease of discussion, the process 600 will be described with reference to the environment 100 of FIG. 1. The process 600 may be implemented at the terminal device 110 and/or the server 160. For ease of description, the process 600 is implemented at the server 160 as an example for description.

It should be noted that, if the process 600 is implemented at the terminal device 110 as an example for description, some operations described with reference to the terminal device 110 may require assistance of the server 160. It should be noted that the operations performed by the terminal device 110 may be specifically performed by a related application and/or a target application installed on the terminal device 110.

As shown in FIG. 6, at block 610, the server 160 receives a first user input during a voice call between a user and a digital assistant, the first user input including at least a first voice input by the user to the digital assistant.

In some embodiments, the first user input further includes reference media content associated with the first voice input, the first voice input indicating a requirement for the reference media content.

At block 620, the server 160 obtains, based on the first user input, first auxiliary content, of a first modality associated with the first user input, where the first modality is determined based on a user requirement indicated by the first user input.

In some embodiments, the first modality is determined by: determining, by analyzing the semantics of the first user input, the user requirement indicated by the first user input; and selecting, from the plurality of modalities, a modality matching the user requirement as the first modality.

In some embodiments, selecting, from a plurality of modalities, a modality matching the user requirement as the first modality includes at least one of: selecting an image as the first modality in response to the user requirement being related to a visual element, selecting an audio as the first modality in response to the user requirement being related to an auditory element, selecting a video as the first modality in response to the user requirement being related to a dynamic scene, or selecting a structured card as the first modality in response to the user requirement being related to an information query.

In some embodiments, obtaining the first auxiliary content of the first modality is in response to determining that the voice reply fails to satisfy the user requirement.

At block 630, the server 160 presents a voice reply for the first user input and a first preview view for the first auxiliary content.

In some embodiments, the process 600 further includes: presenting, in response to receiving a trigger for the first preview view, at least a portion of the first auxiliary content during the voice call.

In some embodiments, the first auxiliary content includes audio content, and the method further includes disabling a voice output of the digital assistant during presentation of at least the portion of the first auxiliary content.

In some embodiments, the process 600 further includes: presenting a subtitle enabling control in an interface of the voice call in response to the first auxiliary content including the voice content; and presenting, in response to a trigger for the subtitle enabling control, text corresponding to the voice content during presentation of at least a portion of the first auxiliary content.

In some embodiments, the process 600 further includes: presenting, in response to obtaining second auxiliary content of the second modality during the voice call, a second preview view for the second auxiliary content, the second preview view being overlapped with at least a portion of the first preview view.

In some embodiments, the second auxiliary content is obtained based on the first user input, and the second preview view is presented during presentation of the voice reply for the first user input.

In some embodiments, the second auxiliary content is obtained by: receiving a second user input during presentation of the first auxiliary content; obtaining, based on the second user input, second auxiliary content, of a second modality, associated with the second user input, where the second preview view is presented during presentation of a voice reply for the second user input.

In some embodiments, the process 600 further includes: presenting, during presentation of at least a portion of the second auxiliary content, at least one of: at least a portion of the first auxiliary content or the voice reply for the first user input in response to receiving a trigger for the first preview view.

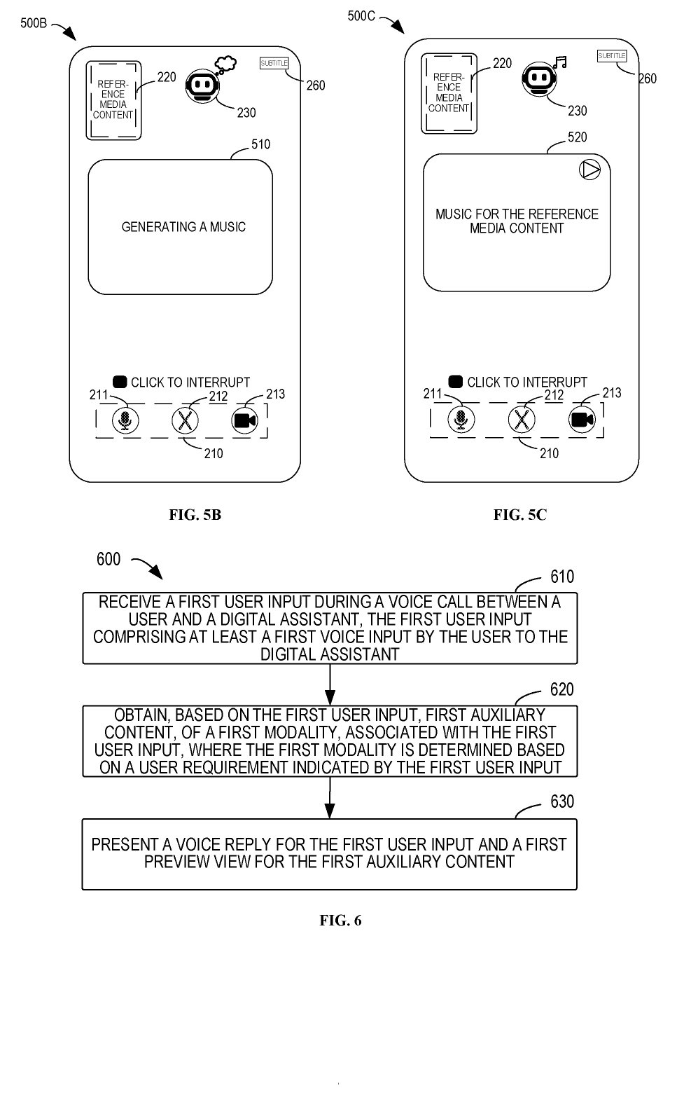

Embodiments of the present disclosure also provide a corresponding apparatus for implementing the above method or process. FIG. 7 illustrates an example structural block diagram of an apparatus 700 for interaction according to some embodiments of the present disclosure. The apparatus 700 may be implemented or included in the terminal device 110 and/or the server 160. The various modules/components in the apparatus 700 may be implemented by hardware, software, firmware, or any combination thereof.

As shown in FIG. 7, the apparatus 700 includes a receiving module 710 configured to receive a first user input during a voice call between a user and a digital assistant, the first user input including at least a first voice input by the user to the digital assistant. The apparatus 700 further includes an obtaining module 720 configured to obtain first auxiliary content, of a first modality, associated with the first user input based on the first user input, where the first modality is determined based on a user requirement indicated by the first user input. The apparatus 700 further includes a presenting module 730 configured to present a voice reply for the first user input and a first preview view for the first auxiliary content.

In some embodiments, the first user input further includes reference media content associated with the first voice input, the first voice input indicating a requirement for the reference media content.

In some embodiments, the obtaining module 720 is further configured to determine, by analyzing semantics of the first user input, the user requirement indicated by the first user input; and select, from a plurality of modalities, a modality matching the user requirement as the first modality.

In some embodiments, the obtaining module 720 is further configured to select, from a plurality of modalities, a modality matching the user requirement as the first modality, including at least one of: selecting an image as the first modality in response to the user requirement being related to a visual element, selecting an audio as the first modality in response to the user requirement being related to an auditory element, selecting a video as the first modality in response to the user requirement being related to a dynamic scene, or selecting a structured card as the first modality in response to the user requirement being related to an information query.

In some embodiments, obtaining the first auxiliary content of the first modality is in response to determining that the voice reply fails to satisfy the user requirement.

In some embodiments, the apparatus 700 further includes a first triggering module configured to, present, in response to receiving a trigger for the first preview view, at least a portion of the first auxiliary content during the voice call.

In some embodiments, the first auxiliary content includes audio content, and the method further includes disabling a voice output of the digital assistant during presentation of at least the portion of the first auxiliary content.

In some embodiments, the apparatus 700 further includes a second triggering module configured to present, in response to the first auxiliary content including the voice content, a subtitle enabling control in an interface of the voice call; and present, in response to a trigger for the subtitle enabling control, text corresponding to the voice content during presentation of at least a portion of the first auxiliary content,.

In some embodiments, the apparatus 700 further includes a preview view presenting module configured to present, in response to obtaining second auxiliary content of a second modality during the voice call, a second preview view for the second auxiliary content, the second preview view being overlapped with at least a portion of the first preview view.

In some embodiments, the second auxiliary content is obtained based on the first user input, and the second preview view is presented during presentation of the voice reply for the first user input.

In some embodiments, the apparatus 700 further includes a second auxiliary content presenting module configured to, receive a second user input during presentation of the first auxiliary content; obtain, based on the second user input, second auxiliary content, of a second modality, associated with the second user input, where the second preview view is presented during presentation of a voice reply for the second user input.

In some embodiments, the apparatus 700 further includes a third triggering module configured to, present, during presentation of at least a portion of the second auxiliary content, at least one of: at least a portion of the first auxiliary content or the voice reply for the first user input in response to receiving a trigger for the first preview view.

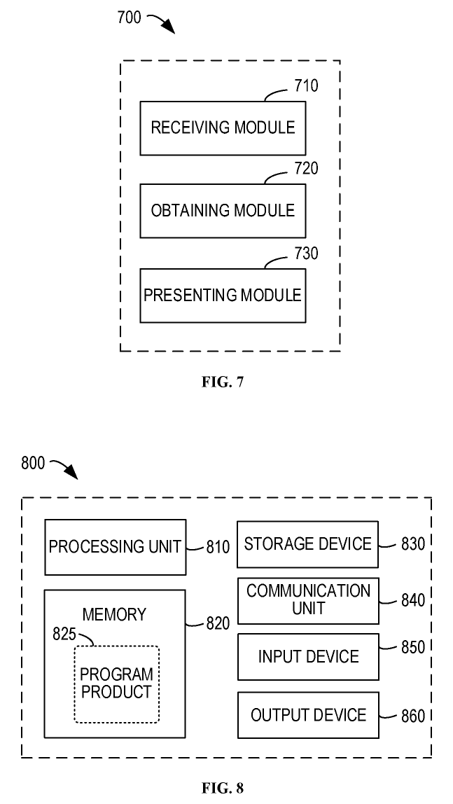

FIG. 8 illustrates a block diagram of an electronic device 800 in which one or more embodiments of the present disclosure may be implemented. It should be understood that the electronic device 800 illustrated in FIG. 8 is merely an example and should not constitute any limitation on the functionality and scope of the embodiments described herein.

As shown in FIG. 8, the electronic device 800 is in the form of a general-purpose electronic device. Components of the electronic device 800 may include, but are not limited to, one or more processors or processing units 810, a memory 820, a storage device 830, one or more communication units 840, one or more input devices 850, and one or more output devices 860. The processing unit 810 may be an actual or virtual processor and configured to execute various processes according to programs stored in the memory 820. In multiprocessor systems, multiple processing units execute computer-executable instructions in parallel to improve parallel processing capabilities of the electronic device 800.

The electronic device 800 typically includes a plurality of computer storage media. Such media may be any available media accessible to the electronic device 800, including, but not limited to, volatile and non-volatile media, removable and non-removable media. The memory 820 may be volatile memory (e.g., registers, caches, random access memory (RAM)), non-volatile memory (e.g., read-only memory (ROM), electrically erasable programmable read-only memory (EEPROM), flash memory), or some combination thereof. The storage device 830 may be a removable or non-removable medium and may include a machine-readable medium, such as a flash drive, magnetic disk, or any other medium, which may be capable of storing information and/or data and may be accessed within electronic device 800.

The electronic device 800 may further include additional removable/non-removable, volatile/non-volatile storage media. Although not shown in FIG. 8, a disk drive for reading or writing from a removable, nonvolatile magnetic disk (e.g., a “floppy disk”) and an optical disk drive for reading or writing from a removable, nonvolatile optical disk may be provided. In these cases, each drive may be connected to a bus (not shown) by one or more data media interfaces. The memory 820 may include a computer program product 825 having one or more program modules configured to perform various methods or actions of various embodiments of the present disclosure.

The communication unit 840 is configured to communicate with another electronic device through a communication medium. Additionally, the functionality of components of the electronic device 800 may be implemented in a single computing cluster or multiple computing machines capable of communicating over a communication connection. Thus, the electronic device 800 may operate in a networked environment using logical connections with one or more other servers, network personal computers (PCs), or another network node.

The input device 850 may be one or more input devices such as a mouse, a keyboard, a trackball, or the like. The output device 860 may be one or more output devices, such as a display, a speaker, a printer, or the like. The electronic device 800 may also communicate with one or more external devices (not shown) through the communication unit 840 as needed, external devices such as storage devices, display devices, etc. , communicate with one or more devices that enable a user to interact with the electronic device 800, or communicate with any device (e.g., a network card, a modem, etc.) that enables the electronic device 800 to communicate with one or more other electronic devices. Such communication may be performed via an input/output (I/O) interface (not shown).

According to example implementations of the present disclosure, a computer-readable storage medium having computer-executable instructions stored thereon is provided, where the computer-executable instructions are executed by a processor to implement the method described above. According to example implementations of the present disclosure, a computer program product is further provided, the computer program product being tangibly stored on a non-transitory computer-readable medium and including computer-executable instructions, the computer-executable instructions being executed by a processor to implement the method described above.

According to example implementations of the present disclosure, a computer program product or a computer program is provided, where the computer program product or the computer program includes computer instructions, and the computer instructions are stored on a computer-readable storage medium. The processor of the computer device reads the computer instructions from the computer-readable storage medium, and the processor executes the computer instructions, so that the computer device executes the method provided in various optional manners in FIG. 8, and therefore, details are not described herein again.

Aspects of the present disclosure are described herein with reference to flowcharts and/or block diagrams of methods, apparatuses, devices, and computer program products implemented in accordance with the present disclosure. It should be understood that each block of the flowchart and/or block diagram, and combinations of blocks in the flowcharts and/or block diagrams, may be implemented by computer readable program instructions.

These computer-readable program instructions may be provided to a processing unit of a general purpose computer, special purpose computer, or other programmable data processing apparatus to produce a machine, such that the instructions, when executed by a processing unit of a computer or other programmable data processing apparatus, produce means to implement the functions/acts specified in the flowchart and/or block diagram. These computer-readable program instructions may also be stored in a computer-readable storage medium that cause the computer, programmable data processing apparatus, and/or other devices to function in a particular manner, such that the computer-readable medium storing instructions includes an article of manufacture including instructions to implement aspects of the functions/acts specified in the flowchart and/or block diagram (s).

The computer-readable program instructions may be loaded onto a computer, other programmable data processing apparatus, or other apparatus, such that a series of operational steps are performed on a computer, other programmable data processing apparatus, or other apparatus to produce a computer-implemented process such that the instructions executed on a computer, other programmable data processing apparatus, or other apparatus implement the functions/acts specified in the flowchart and/or block diagram block or blocks.

The flowchart and block diagrams in the figures show architecture, functionality, and operation of possible implementations of systems, methods, and computer program products according to various implementations of the present disclosure. In this regard, each block in the flowchart or block diagram may represent a module, program segment, or portion of an instruction that includes one or more executable instructions for implementing the specified logical function. In some alternative implementations, the functions noted in the blocks may also occur in a different order than noted in the figures. For example, two consecutive blocks may actually be performed substantially in parallel, which may sometimes be performed in the reverse order, depending on the functionality involved. It is also noted that each block in the block diagrams and/or flowchart, as well as combinations of blocks in the block diagrams and/or flowchart, may be implemented with a dedicated hardware-based system that performs the specified functions or actions, or may be implemented in a combination of dedicated hardware and computer instructions.

Various implementations of the present disclosure have been described above, which are example, not exhaustive, and are not limited to the implementations disclosed. Many modifications and variations will be apparent to those of ordinary skill in the art without departing from the scope and spirit of the various implementations illustrated. The selection of the terms used herein is intended to best explain the principles of the implementations, practical applications, or improvements to techniques in the marketplace, or to enable others of ordinary skill in the art to understand the various implementations disclosed herein.

1. A method for interaction, comprising:
receiving a first user input during a voice call between a user and a digital assistant, the first user input comprising at least a first voice input by the user to the digital assistant;
obtaining, based on the first user input, first auxiliary content, of a first modality, associated with the first user input, wherein the first modality is determined based on a user requirement indicated by the first user input; and
presenting a voice reply for the first user input and a first preview view for the first auxiliary content.

2. The method of claim 1, further comprising:
presenting, in response to receiving a trigger for the first preview view, at least a portion of the first auxiliary content during the voice call.

3. The method of claim 2, wherein the first auxiliary content comprises audio content, and the method further comprises:
disabling a voice output of the digital assistant during presentation of at least the portion of the first auxiliary content.

4. The method of claim 1, further comprising:
presenting, in response to obtaining second auxiliary content of a second modality during the voice call, a second preview view for the second auxiliary content, the second preview view being overlapped with at least a portion of the first preview view.

5. The method of claim 4, wherein the second auxiliary content is obtained based on the first user input, and the second preview view is presented during presentation of the voice reply for the first user input.

6. The method of claim 4, wherein the second auxiliary content is obtained by:
receiving a second user input during presentation of the first auxiliary content; and
obtaining, based on the second user input, second auxiliary content, of a second modality, associated with the second user input, wherein the second preview view is presented during presentation of a voice reply for the second user input.

7. The method of claim 4, further comprising:
presenting, during presentation of at least a portion of the second auxiliary content, at least one of: at least a portion of the first auxiliary content or the voice reply for the first user input in response to receiving a trigger for the first preview view.

8. The method of claim 1, wherein the first modality is determined by:
determining, by analyzing semantics of the first user input, the user requirement indicated by the first user input; and
selecting, from a plurality of modalities, a modality matching the user requirement as the first modality.

9. The method of claim 8, wherein selecting, from a plurality of modalities, a modality matching the user requirement as the first modality comprises at least one of:
selecting an image as the first modality in response to the user requirement being related to a visual element,
selecting an audio as the first modality in response to the user requirement being related to an auditory element,
selecting a video as the first modality in response to the user requirement being related to a dynamic scene, or
selecting a structured card as the first modality in response to the user requirement being related to an information query.

10. The method of claim 8, wherein obtaining the first auxiliary content of the first modality is in response to determining that the voice reply fails to satisfy the user requirement.

11. The method of claim 1, wherein the first user input further comprises reference media content associated with the first voice input, and the first voice input indicats a requirement for the reference media content.

12. The method of claim 1, further comprising:
presenting a subtitle enabling control in an interface of the voice call in response to the first auxiliary content comprising voice content; and
presenting, in response to a trigger for the subtitle enabling control, text corresponding to the voice content during presentation of at least a portion of the first auxiliary content.

13. An electronic device, comprising:
at least one processor; and
at least one memory coupled to the at least one processor and storing instructions for execution by the at least one processor, wherein the instructions, when executed by the at least one processor, cause the electronic device to perform acts comprising:
receiving a first user input during a voice call between a user and a digital assistant, the first user input comprising at least a first voice input by the user to the digital assistant;
obtaining, based on the first user input, first auxiliary content, of a first modality, associated with the first user input, wherein the first modality is determined based on a user requirement indicated by the first user input; and
presenting a voice reply for the first user input and a first preview view for the first auxiliary content.

14. The electronic device of claim 13, wherein the acts further comprise:
presenting, in response to receiving a trigger for the first preview view, at least a portion of the first auxiliary content during the voice call.

15. The electronic device of claim 14, wherein the first auxiliary content comprises audio content, and the atcs further comprise:
disabling a voice output of the digital assistant during presentation of at least the portion of the first auxiliary content.

16. The electronic device of claim 13, wherein the acts further comprise:
presenting, in response to obtaining second auxiliary content of a second modality during the voice call, a second preview view for the second auxiliary content, the second preview view being overlapped with at least a portion of the first preview view.

17. The electronic device of claim 16, wherein the second auxiliary content is obtained based on the first user input, and the second preview view is presented during presentation of the voice reply for the first user input.

18. The electronic device of claim 16, wherein the second auxiliary content is obtained by:
receiving a second user input during presentation of the first auxiliary content; and
obtaining, based on the second user input, second auxiliary content, of a second modality, associated with the second user input, wherein the second preview view is presented during presentation of a voice reply for the second user input.

19. The electronic device of claim 16, wherein the acts further comprise:
presenting, during presentation of at least a portion of the second auxiliary content, at least one of: at least a portion of the first auxiliary content or the voice reply for the first user input in response to receiving a trigger for the first preview view.

20. A non-transitory computer-readable storage medium having stored thereon a computer program executable by a processor to implement acts comprising:
receiving a first user input during a voice call between a user and a digital assistant, the first user input comprising at least a first voice input by the user to the digital assistant;
obtaining, based on the first user input, first auxiliary content, of a first modality, associated with the first user input, wherein the first modality is determined based on a user requirement indicated by the first user input; and
presenting a voice reply for the first user input and a first preview view for the first auxiliary content.
